(19) United States
(12) Patent Application Publication
(10) Pub. No.: US 2013/0068606 A1
(43) Pub. Date: Mar. 21, 2013

(54) FLUID AGITATOR FOR USE IN AN IMMERSION COOLER

(71) Applicant: Gerhard A. Lahnstein, Brohl-Lutzing (DE)

(72) Inventor: Gerhard A. Lahnstein, Brohl-Lutzing (DE)

(73) Assignee: Heatcraft Refrigeration Products LLC, Stone Mountain, GA (US)

(21) Appl. No.: 13/233,712

(22) Filed: Sep. 15, 2011

(51) Int. Cl. F25B 39/02; B23P 15/26; B01F 15/02

(52) U.S. Cl. 202/175; 366/164.1; 29/890.035

(57) ABSTRACT

An immersion cooler comprising an agitator motor having a drive shaft, an evaporator located in a tank and surrounding the drive shaft, and an agitator coupled to the drive shaft. The agitator is configured to draw a fluid from the tank and distribute the fluid around a periphery of the agitator and toward the evaporator. An agitator and a method of manufacturing an immersion cooler are also provided.

### TECHNICAL FIELD

This application is directed, in general, to a fluid agitator and, more specifically, to a fluid agitator for use in an immersion cooler.

### BACKGROUND

Immersion coolers are regularly used to remove heat from a variety of liquids. By their nature, an immersion cooler may have a basket evaporator, generally of stainless steel tubing in a coil that rests in a tank containing the liquid to be cooled. The compressor, air cooled condenser and other equipment necessary for the refrigeration cycle will be located structurally above or in close proximity to the basket evaporator. An agitator is commonly used to thoroughly mix the liquid to be cooled. The type of liquid to be cooled is dictated by the application of the liquid, e.g., cooling/lubricating a machine part being shaped by a machine tool may require cutting oil. The type of agitator is usually selected based upon the viscosity of the liquid that will be agitated. For liquids having an oil-like viscosity, a simple paddle is used coupled to the agitator motor drive shaft. For liquids having an emulsion-like viscosity, a ship propeller-type agitator is used coupled to the agitator motor drive shaft. Therefore, the type of agitator limits the usefulness of the immersion cooler by limiting the viscosity of the fluid that it agitates as well as complicates manufacturing of the immersion cooler.

### SUMMARY

One aspect provides an immersion cooler comprising an agitator motor having a drive shaft, an evaporator located in a tank and surrounding the drive shaft, and an agitator coupled to the drive shaft. The agitator is configured to draw a fluid from the tank, through an opening in the bottom of the agitator and distribute the fluid around a periphery of the agitator and into the tank.

Another aspect provides a fluid agitator comprising a drive motor having a drive shaft and an agitator coupled to the drive shaft. The agitator is configured to draw a fluid from a tank in which the agitator is positioned, through an opening in the bottom of the agitator and distribute the fluid about a periphery of the agitator.

Yet another aspect provides a method of manufacturing an immersion cooler comprising providing an agitator motor having a drive shaft and an agitator coupled thereto. The agitator is configured to draw a fluid from a tank, through an opening in the bottom of the agitator and distribute the fluid around a periphery of the agitator. The agitator is positioned adjacent an evaporator.

### BRIEF DESCRIPTION

Reference is now made to the following descriptions taken in conjunction with the accompanying drawings, in which:

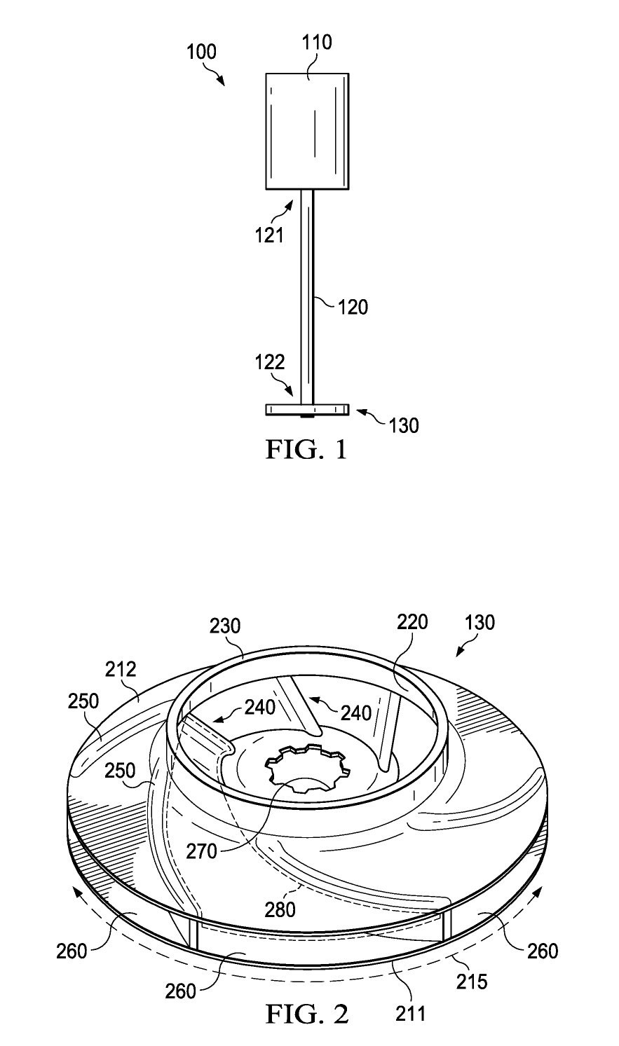

FIG. 1 is an elevation view of one embodiment of an immersion cooler agitator assembly 100 constructed according to the principles of the present disclosure;

FIG. 2 is a bottom perspective view of one embodiment of the agitator 130 of FIG. 1;

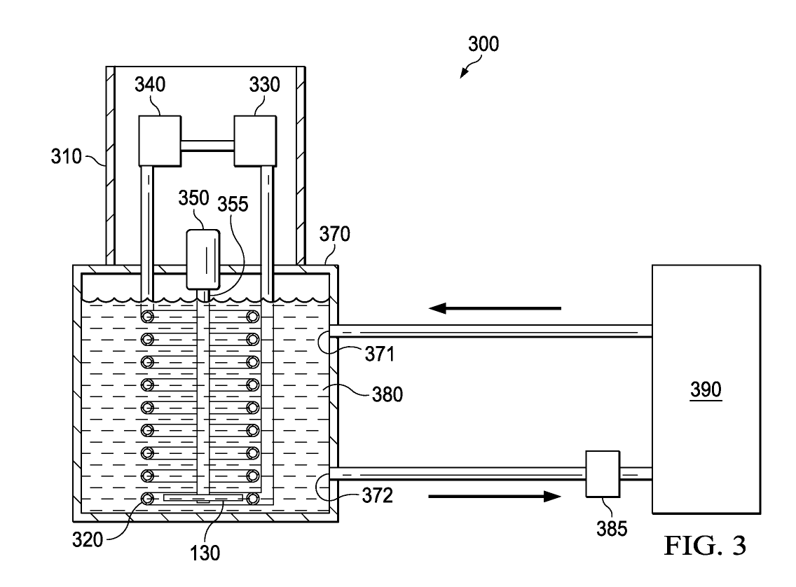

FIG. 3 is a partial sectional view of one embodiment of an immersion cooler 300 constructed in accordance with the present disclosure; and

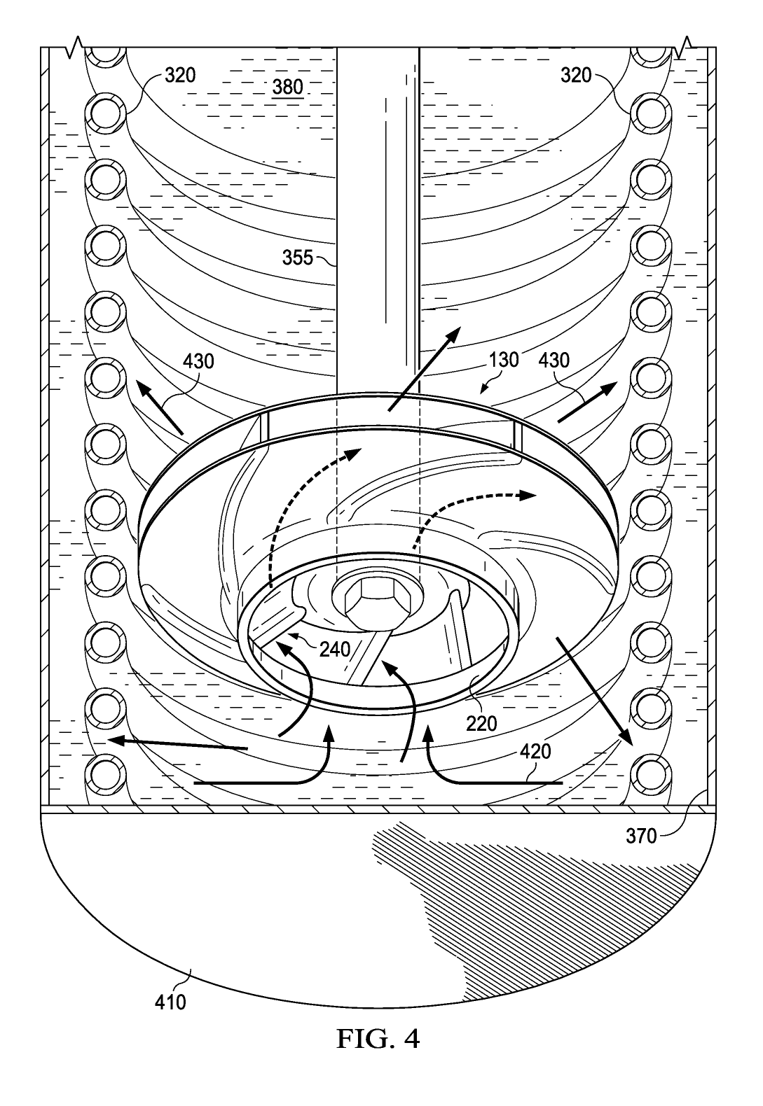

FIG. 4 is a bottom perspective view of the agitator 360 of FIG. 3 with flow pattern of the fluid 380 shown.

### DETAILED DESCRIPTION

Referring initially to FIG. 1, illustrated is an elevation view of one embodiment of an agitator assembly 100 constructed according to the principles of the present disclosure. In this embodiment, the agitator assembly 100 comprises an agitator drive motor 110, a drive shaft 120 and an agitator 130. The drive shaft 120 is coupled to the agitator drive motor 110 at a first end 121 and to the agitator 130 at a second end 122.

Referring now to FIG. 2, illustrated is a bottom perspective view of one embodiment of the agitator 130 of FIG. 1. The agitator 130 comprises an upper disk 211, a lower disk 212, a central opening 220, a collar 230, a plurality of inlet apertures 240, a corresponding plurality of vanes 250, a corresponding plurality of outlet apertures 260 and a drive shaft aperture 270. It should be noted that though the vanes 250 as illustrated are arcuate, they may also be straight or have another linear geometry, such as a serpentine configuration. The central opening 220 is surrounded by an optional collar 230 and reveals the plurality of inlet apertures 240 proximate the center of the lower disk 212. The corresponding plurality of vanes 250 extend from the inlet apertures 240 to the outlet apertures 260 on a periphery 215 of the agitator 130, thereby creating a corresponding plurality of channels 280.

In one aspect, the plurality of channels 280 may have a nautilus-shaped planform, i.e., a section of the agitator 130 parallel the upper disk 211 through the plurality of channels 280 appears as a like plurality of arcuate voids commencing at the inlet apertures 240 and growing larger with a curve toward the outlet apertures 260. However, the voids may also be straight or have another linear geometry, similar to the vanes 250. In one embodiment, the agitator 130 is a single agitator; however, in an alternative embodiment, more than one agitator may be coupled along the drive shaft 120. One who is of skill in the art will readily understand how the corrugated drive shaft aperture 270 couples to complementary flutes (not shown) on the drive shaft 120.

Referring now to FIG. 3, illustrated is a partial sectional view of one embodiment of an immersion cooler 300 constructed in accordance with the present disclosure. It should be understood that the agitator of FIG. 1 may be employed in any apparatus in which a fluid needs to be agitated, including the immersion cooler 300 as discussed herein.

In the illustrated embodiment, the immersion cooler 300 comprises a frame 310, an evaporator coil 320, a condenser 330, a compressor 340, an agitator drive motor 350, a drive shaft 355 and the agitator 130. The immersion cooler 300 is used in conjunction with a tank 370 containing a fluid 380 to be cooled by the immersion cooler 300. For ease of operation, the evaporator coil 320 may be formed in a shape similar to a basket and may be termed a basket evaporator 320. The tank 370 comprises an inlet 371 and an outlet 372 through which the fluid 380 circulates. The sealed refrigeration circuit, i.e., the evaporator coil, condenser 330, and compressor 340, cools a refrigerant therein and through the basket evaporator coil 320 draws heat from the fluid 380 to be cooled. In one embodiment, the fluid 380 to be cooled may be cutting oil as for use in on an industrial machine tool 390. An external pump 385 may be used to facilitate transfer of the cooled fluid 380 from the tank 370 to a machine tool 390 where the fluid may be used to cool moving parts of the machine tool 390. An additional pump (not shown) may also be used to draw the fluid 380 from the machine tool for return to the tank 370. Of course, other applications to which immersion coolers are applicable may also be used, e.g., water chiller, etc., or any application where turbulence in a liquid to be cooled optimizes the heat transfer.

Referring now to FIG. 4 with continuing reference to FIGS. 2 and 3, illustrated is a bottom perspective view of the agitator 130 of FIG. 3 with flow pattern of the fluid 380 shown. Driven by drive shaft 355, the agitator 130 causes fluid 380 to be drawn into the central opening 220 from the tank 370 as shown in flow 420. The fluid 380 flows through inlet apertures 240 and along the plurality of channels 280, exiting the agitator periphery 215 at the plurality of outlet apertures 260 with significant force as shown in outflow 430. Outflow 430 is directed radially outward from the agitator 130 toward the evaporator coil 320. The amount of turbulence created can be controlled by the rotational speed of the drive shaft 355. It should be noted that when the agitator 130 draws fluid 380 from proximate the bottom 410 of the tank 370, air bubbles are minimized in the outflow 430 from the agitator 130 as compared to paddle-type agitators. A particular advantage to the described agitator 130 is that it can be used with a variety of fluids having significantly different viscosities, i.e., from water to oil to emulsions interchangeably. This makes manufacturing and maintenance much simpler than having different types of agitators for different types of fluids, e.g., paddle agitators for oil and propeller types for emulsions. Additionally, the risk of injury to an operator by touching the running agitator is minimized.

For the purposes of this discussion, use of the terms “providing” and “forming,” etc., includes: manufacture, subcontracting, purchase, etc. Those skilled in the art to which this application relates will appreciate that other and further additions, deletions, substitutions and modifications may be made to the described embodiments.

What is claimed is:

1. An immersion cooler, comprising:
an agitator motor having a drive shaft;
an evaporator located in a tank and surrounding said drive shaft; and
an agitator coupled to said drive shaft, said agitator configured to draw a fluid from said tank, through an opening in a bottom of said agitator and distribute said fluid around a periphery of said agitator and into said tank.

2. The immersion cooler as recited in claim 1 wherein said agitator comprises a disk having a plurality of inlet apertures proximate a center of said disk.

3. The immersion cooler as recited in claim 2 wherein said agitator has a collar surrounding a central opening in said bottom of said agitator, said central opening exposing said inlet apertures.

4. The immersion cooler as recited in claim 2 wherein said agitator further comprises a corresponding plurality of fluid channels extending from said plurality of inlet apertures to a corresponding plurality of outlet apertures on said periphery.

5. The immersion cooler as recited in claim 4, wherein said channels are formed by arcuate vanes.

6. The immersion cooler as recited in claim 5 wherein each of said plurality of channels has a nautilus-shaped planform.

7. The immersion cooler as recited in claim 1 wherein said agitator is a first agitator and said immersion cooler further includes at least a second agitator.

8. A fluid agitator, comprising:
a drive motor having a drive shaft; and
an agitator coupled to said drive shaft, said agitator configured to draw a fluid from a tank in which said agitator is positioned, through an opening located in a bottom of said agitator and distribute said fluid about a periphery of said agitator.

9. The fluid agitator as recited in claim 8 wherein said agitator comprises a disk having a plurality of inlet apertures proximate a center of said disk.

10. The fluid agitator as recited in claim 9 wherein said agitator has a collar surrounding a central opening, said central opening exposing said inlet apertures.

11. The fluid agitator as recited in claim 9 wherein said agitator further comprises a corresponding plurality of fluid channels extending from said plurality of inlet apertures to a corresponding plurality of outlet apertures on said periphery.

12. The fluid agitator as recited in claim 11 wherein said channels are formed by arcuate vanes.

13. The fluid agitator as recited in claim 12 wherein each of said plurality of channels has a nautilus-shaped planform.

14. A method of manufacturing an immersion cooler, comprising:
providing an agitator motor having a drive shaft and an agitator coupled thereto, said agitator configured to draw a fluid from a tank, through an opening in a bottom of said agitator and distribute said fluid around a periphery of said agitator; and
positioning said agitator adjacent an evaporator.

15. The method as recited in claim 14 wherein said agitator comprises a disk having a plurality of inlet apertures proximate a center of said disk.

16. The method as recited in claim 15 wherein said agitator includes a collar surrounding a central opening, said central opening exposing said inlet apertures.

17. The method as recited in claim 15 wherein said agitator further comprises a corresponding plurality of fluid channels extending from said plurality of inlet apertures to a corresponding plurality of outlet apertures on said periphery.

18. The method as recited in claim 17 wherein said channels are formed by arcuate vanes.

19. The method as recited in claim 18 wherein each of said channels has a nautilus-like planform.

20. The method as recited in claim 14 wherein providing includes providing includes providing an agitator motor having a drive shaft and a plurality of said agitators coupled thereto.
